(19) United States
(12) Patent Application Publication
(10) Pub. No.: US 2026/0108897 A1
(43) Pub. Date: Apr. 23, 2026

(54) LAWN SPRINKLER

(71) Applicant: Benjamin Garcia, Katy, TX (US)

(72) Inventor: Benjamin Garcia, Katy, TX (US)

(21) Appl. No.: 18/923,076

(22) Filed: Oct. 22, 2024

(51) Int. Cl. B05B 3/04; B05B 3/06; B05B 15/74

(52) U.S. Cl. CPC B05B 3/04; B05B 3/06; B05B 15/74

(57) ABSTRACT

A sprinkler apparatus for distributing water evenly over a lawn includes a base which is configured to attach to a fluid source and defines a volume therein. A riser is mounted to the base and is positionable in an extended configuration in which the riser extends upwardly from and with respect to the base. A sprayer is rotatably coupled to the riser opposite the base. The sprayer comprises a hub and a plurality of spoke tubes. The spoke tubes are coupled to and extend outwardly from the hub. The hub defines a first inlet which is in fluid communication with each spoke tube of the plurality of spoke tubes. Each spoke tube has an outlet opposite the hub and is in fluid communication with the volume of the base via the first inlet of the hub.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to sprinkler apparatus and more particularly pertains to a new sprinkler apparatus for distributing water or other fluids evenly over a lawn or other application surface.

### (2) Description of Related Art including information disclosed under 37 CFR 1.97 and 1.98.

The prior art discloses myriad lawn sprinklers, including those which extend out of the ground when urged by water pressure to rise above a lawn and distribute water over the lawn. However, the prior art fails to describe a telescopic riser comprising multiple tube segments and a sprayer at the top of the riser which distributes water evenly across a watering range of the lawn.

### BRIEF SUMMARY OF THE INVENTION

An embodiment of the disclosure meets the needs presented above by generally comprising a base which is configured to attach to a fluid source and defines a volume therein. A riser is mounted to the base and is positionable in an extended configuration in which the riser extends upwardly from and with respect to the base. A sprayer is rotatably coupled to the riser opposite the base. The sprayer comprises a hub and a plurality of spoke tubes. The spoke tubes are coupled to and extend outwardly from the hub. The hub defines a first inlet which is in fluid communication with each spoke tube of the plurality of spoke tubes. Each spoke tube has an outlet opposite the hub and is in fluid communication with the volume of the base via the first inlet of the hub.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a sprinkler apparatus according to an embodiment of the disclosure with a riser in an extended configuration.

FIG. 2 is a front view of an embodiment of the disclosure with a riser in a retracted configuration.

FIG. 3 is a top view of an embodiment of the disclosure.

FIG. 4 is a bottom view of an embodiment of the disclosure.

FIG. 5 is a cross section view of an embodiment of the disclosure with a riser in an extended configuration taken from Line 5-5 in FIG. 3.

FIG. 6 is a cross section view of an embodiment of the disclosure with a riser in a retracted configuration taken from Line 6-6 in FIG. 2.

FIG. 7 is an exploded perspective view of an embodiment of the disclosure showing detail of a sprayer of the embodiment.

FIG. 8 is a detail side view of a sprayer of an embodiment of the disclosure.

FIG. 9 is a detail cross section view of a sprayer of an embodiment of the disclosure.

FIG. 10 is a cross section view of an embodiment of the disclosure taken from Line 10-10 in FIG. 1.

FIG. 11 is a cross section view of an embodiment of the disclosure taken from Line 11-11 in FIG. 1.

FIG. 12 is an in-use view of an embodiment of the disclosure with the embodiment positioned in the ground, a riser extending upwardly from the ground, and the embodiment dispersing water onto a lawn of grass.

### DETAILED DESCRIPTION OF THE INVENTION

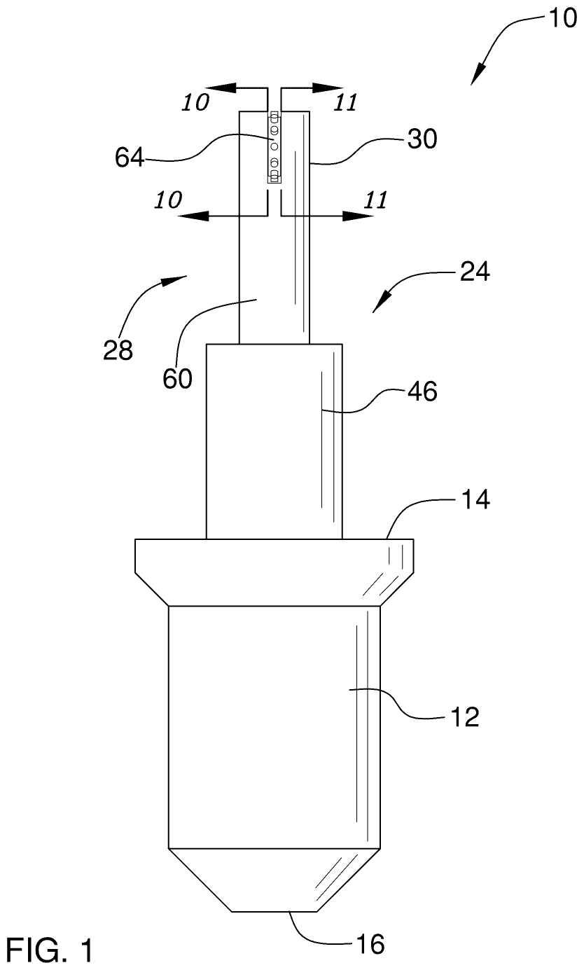

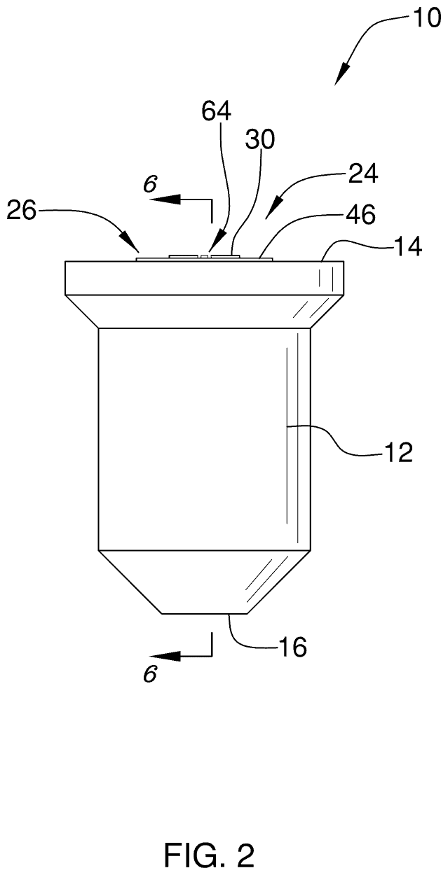

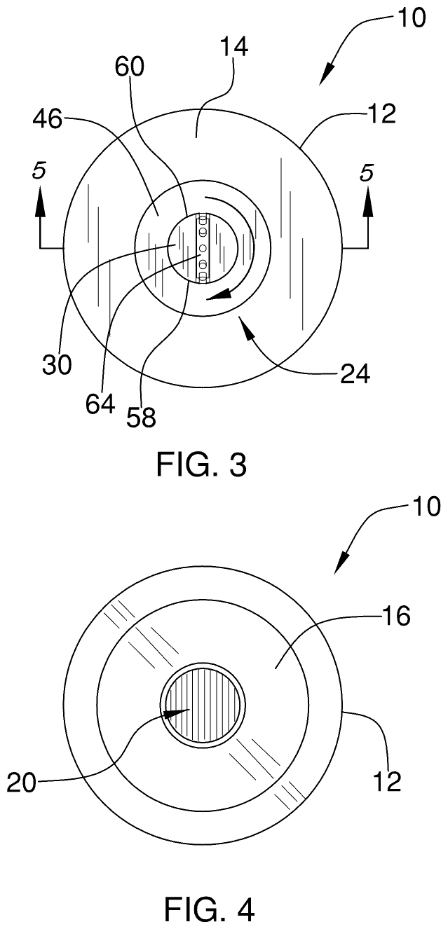

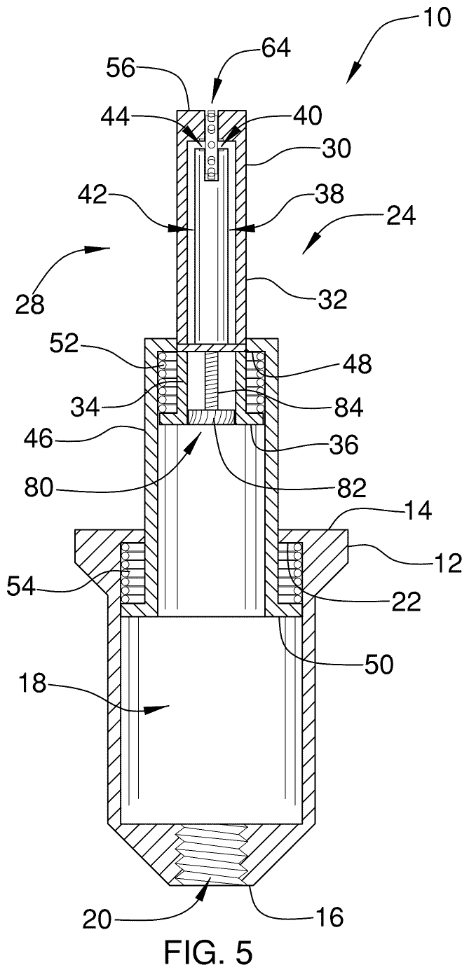

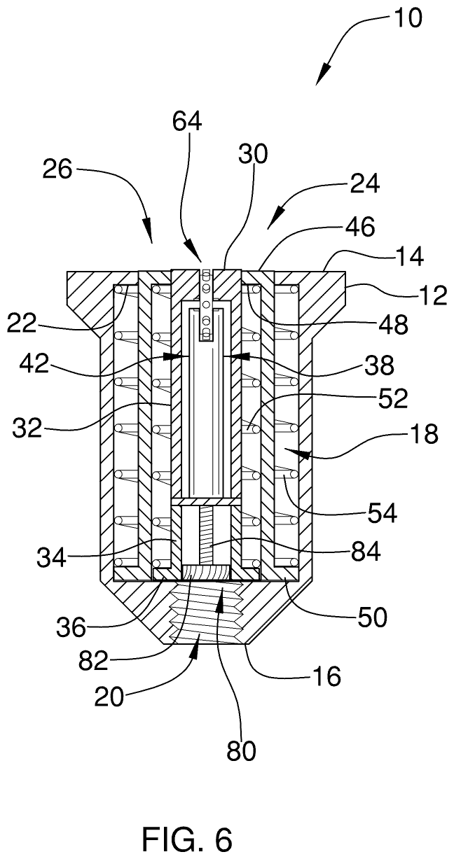

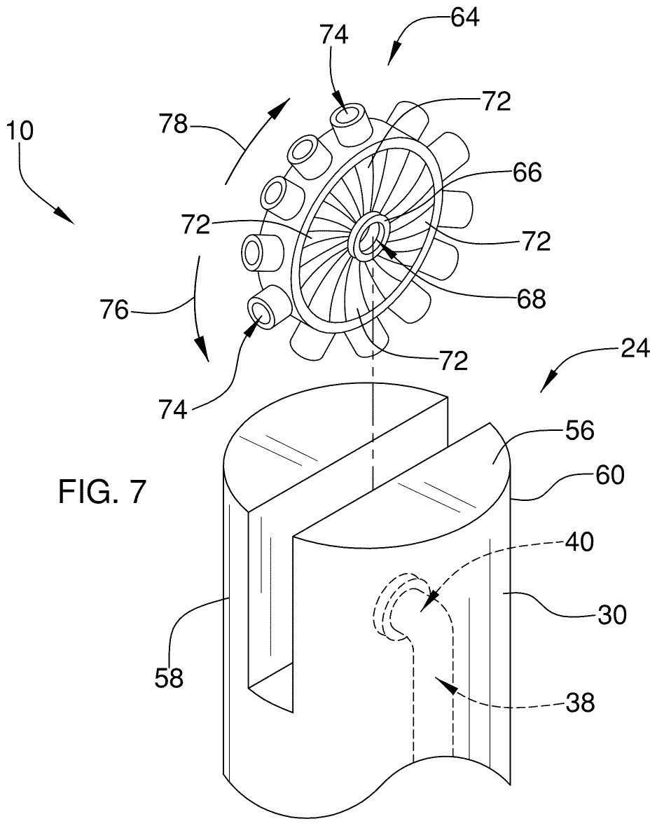

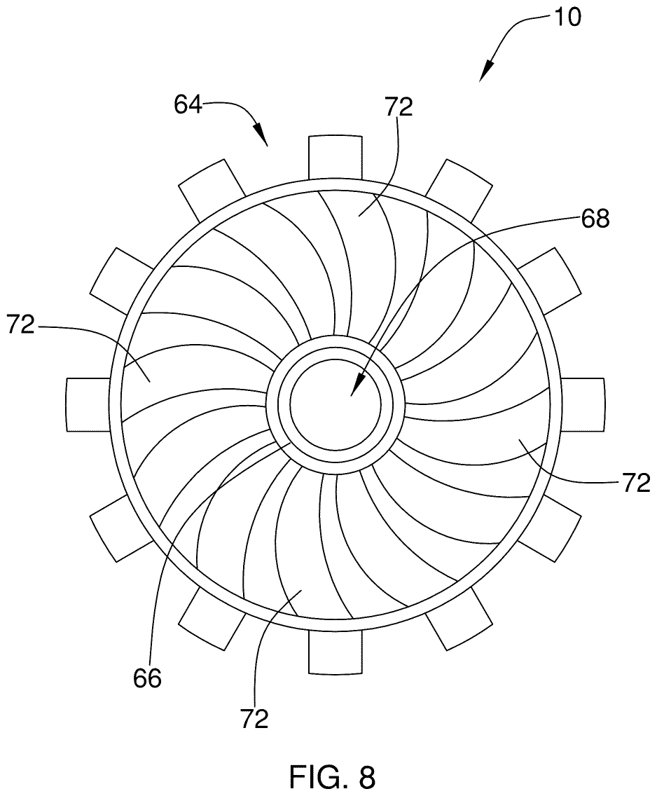

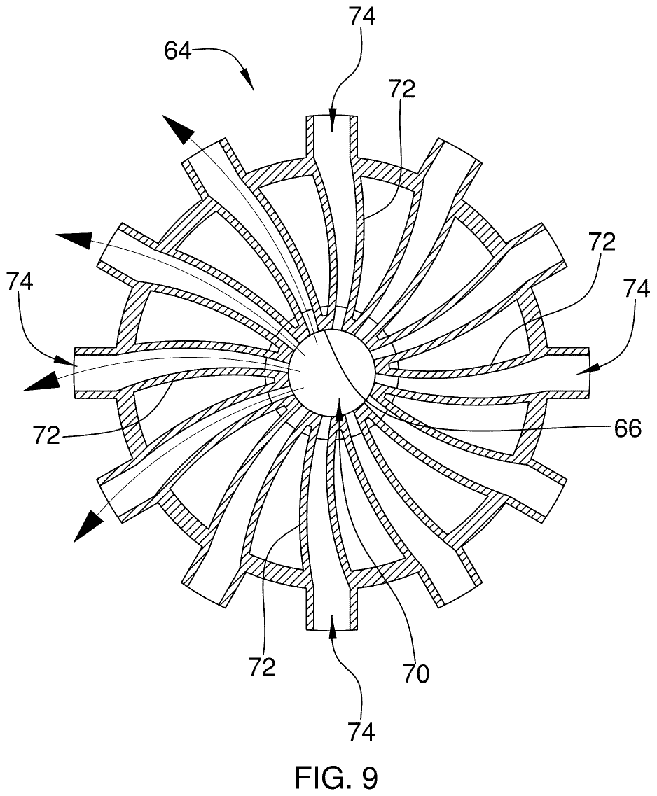

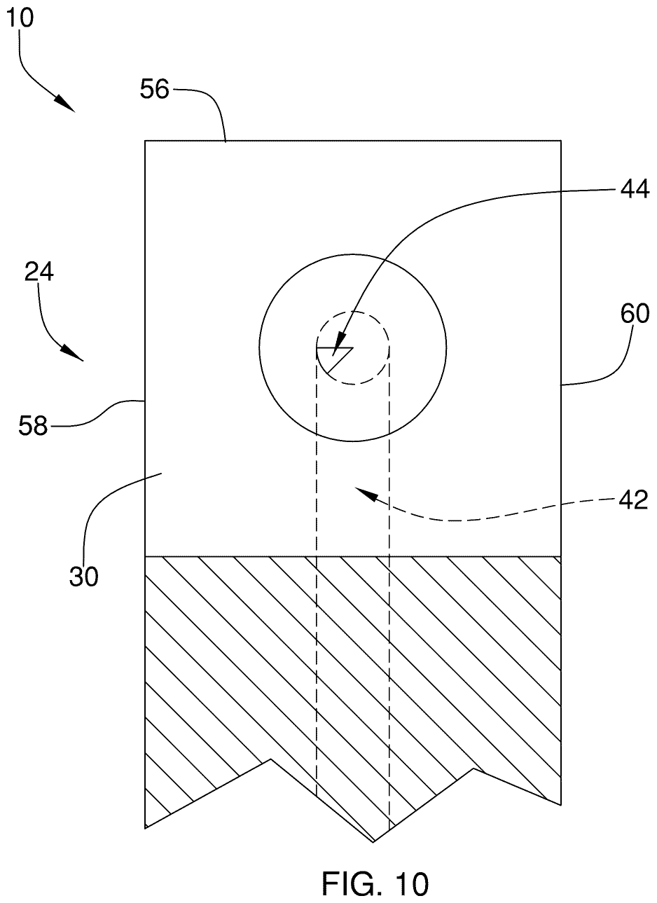

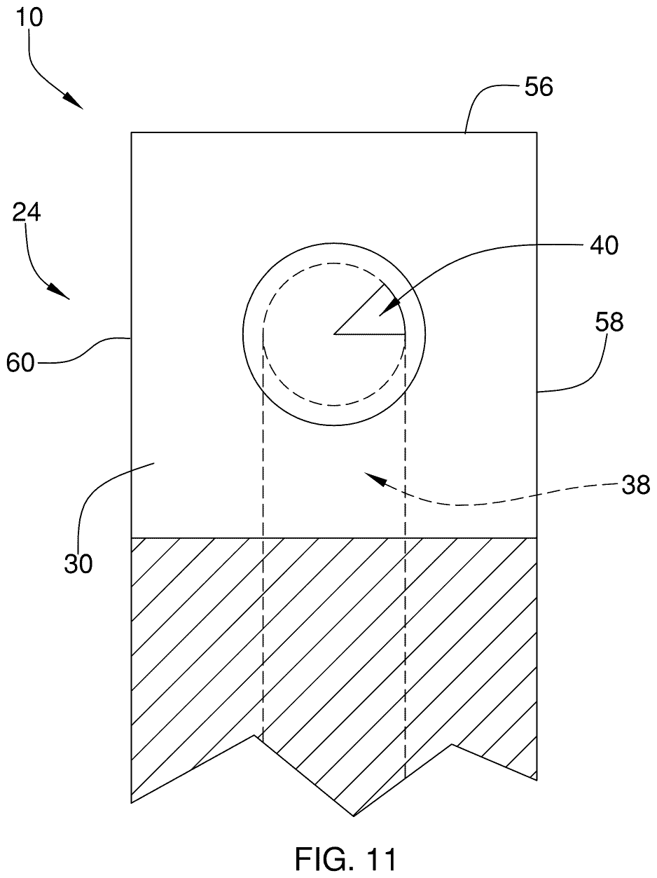

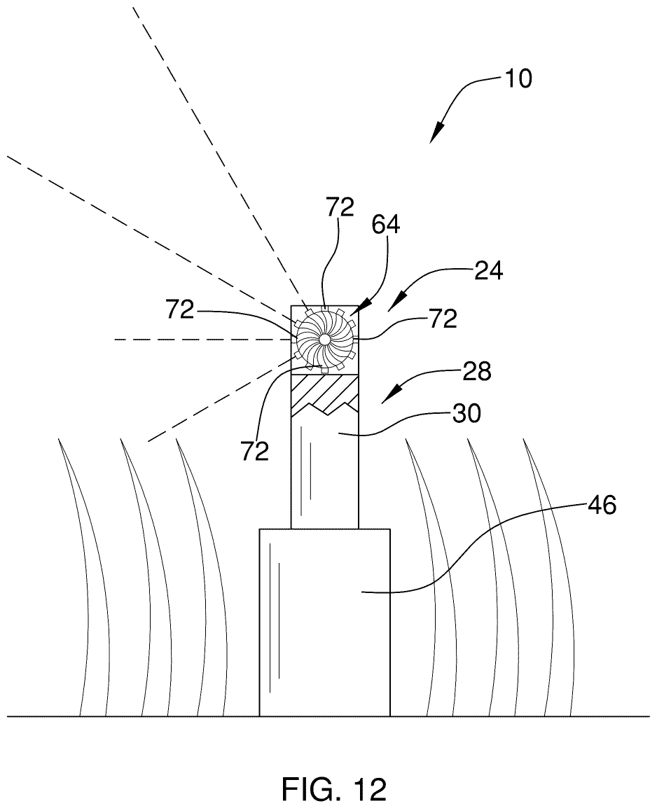

With reference now to the drawings, and in particular to FIGS. 1 through 12 thereof, a new sprinkler apparatus embodying the principles and concepts of an embodiment of the disclosure and generally designated by the reference numeral 10 will be described.

As best illustrated in FIGS. 1 through 12, the sprinkler apparatus 10 generally comprises a base 12 which defines a volume 18 therein and defines an inlet 20 to the volume 18 at a bottom end 16 of the base 12. The inlet 20 is internally threaded to attach the base 12 to a pipe or other fluid source with a complementary external threading. The base 12 may also attach to a fluid source via welded socket joint, a clamp, a force fit, or other suitable fastening means. The base 12 has a top end 14 opposite the bottom end 16. The base 12 may be buried in ground soil in an upright position (i.e., with the top end 14 facing upwardly from the ground soil), however, other orientations may also be used as is suitable for the application.

A riser 24 is mounted to the base 12 which is movable between a retracted configuration 26 and an extended configuration 28 with respect to the base 12. A sprayer 64 is attached to the riser 24 and is positioned to be spaced above the top end 14 of the base 12 during use when the riser 24 is in the extended configuration 28. The riser 24 is positioned substantially in the volume 18 of the base 12 when in the retracted configuration 26 and extends upwardly from and with respect to the base 12 when in the extended configuration 28. The riser 24 is telescopically extendable from the retracted configuration 26 to the extended configuration 28. The riser 24 comprises an upper segment 30 and a lower segment 46, wherein the upper segment 30 is substantially housed in the lower segment 46 and the lower segment 46 is substantially housed in the base 12 when the riser 24 is in the retracted configuration 26. When the riser 24 is in the extended configuration 28, the upper segment 30 extends away from the lower segment 46, and the lower segment 46 extends between the upper segment 30 and the base 12. Additional segments may be used to facilitate the upper segment 30 rising to a desired distance away from the surface of the ground soil when the riser 24 is in the extended configuration 28.

The riser 24 is biased toward the retracted configuration 26 via an upper compression spring 52 and a lower compression spring 54. The upper compression spring 52 is positioned between a bottom flange 36 of the upper segment 30 of the riser 24 and a top inner surface 48 of the lower segment 46 of the riser 24, and the lower compression spring 54 is positioned between a lower flange 50 of the lower segment 46 of the riser 24 and a top interior surface 22 of the base 12. Other biasing means may be used, such as extension springs, torsion springs, elastic bands, gravity-powered mechanisms, or the like.

The sprayer 64 is rotatably coupled to an upper end 56 of the upper segment 30 of the riser 24. The upper segment 30 has a front side 58 and a rear side 60. As described further below, the sprayer 64 is configured to dispense water or other fluids forwardly with respect to the upper segment 30. The sprayer 64 is oriented to rotate about a horizontal axis with respect to the base 12 which extends through the sprayer 64. The horizontal axis also extends laterally with respect to the upper segment 30 of the riser 24. However, other orientations may be used. The sprayer 64 comprises a hub 66 and a plurality of spoke tubes 72. The spoke tubes 72 are coupled to and extend outwardly from the hub 66. The hub 66 defines a first inlet 68 and a second inlet 70 which are positioned opposite each other and are each in fluid communication with each spoke tube 72. Each spoke tube 72 has an outlet 74 opposite the hub 66. The horizontal axis extends through the hub 66. Each spoke tube 72 of the plurality of spoke tubes 72 is curved from the hub 66 in a first rotational direction 76 around the hub 66, the first rotational direction 76 extending around the horizontal axis of the sprayer 64. As water or another fluid is urged through the sprayer 64, the water is forced against inner surfaces of the spoke tubes 72 such that the sprayer 64 is rotated in a second rotational direction 78 opposite the first rotational direction 76.

The upper segment 30 and the lower segment 46 of the riser 24 are hollow to permit water from the volume 18 of the base 12 to flow therethrough to the sprayer 64. The upper segment 30 more particularly defines a first channel 38 and a second channel 42 such that water urged into the riser 24 from the base 12 is diverted into two flows. The first inlet 68 of the sprayer 64 is in fluid communication with the volume 18 of the base 12 via the first channel 38, and the second inlet 70 of the sprayer 64 is in fluid communication with the volume 18 of the base 12 via the second channel 42. The first channel 38 has a bore size which is greater than a bore size of the second channel 42. An outlet 40 of the first channel 38 and an outlet 44 of the second channel 42 are oriented to direct fluid away forwardly with respect to the upper segment 30 of the riser 24 when the fluid exits the first channel 38 and the second channel 42 into the hub 66 of the sprayer 64. The outlet 40 of the first channel 38 is positioned above the outlet 44 of the second channel 42. In this manner, water or other fluid which flows through the first channel 38 will be directed toward spoke tubes 72 whose outlets 74 are generally aimed forwardly and upwardly with respect to the riser 24, while fluid which flows through the second channel 42 will be directed toward spoke tubes 72 whose outlets 74 are aimed generally forwardly and downwardly with respect to the riser 24.

A rotation mechanism 80 is operatively coupled to the upper segment 30 of the riser 24. The rotation mechanism 80 is configured to rotate a rotary portion 32 of the upper segment 30 about a vertical axis which extends through a top end 14 and the bottom end 16 of the base 12. The rotation mechanism 80 comprises a turbine 82 which is mounted in a base portion 34 of the upper segment 30 and a gearbox 84 which operatively couples the turbine 82 to the rotary portion 32 of the upper segment 30. The sprayer 64 is mounted on the rotary portion 32 of the upper segment 30. As water or other fluid flows through the turbine 82 from the base 12 toward the sprayer 64, the turbine 82 is urged to operate the gearbox 84 to rotate the rotary portion 32 of the upper segment 30 about the vertical axis. Other suitable rotary mechanisms may be used. For example, a turbine 82 without a gearbox 84 may be used, or other conventional mechanisms for rotating a sprinkler head via water flow may be used. A motor or the like which may use an alternative energy source from the water may be used in some embodiments.

In use, water or other fluid is pumped into the inlet 20 of the base 12 into the volume 18 with a force sufficient to overcome the bias of the riser 24 toward the retracted configuration 26. The riser 24 is then moved by the water into the extended configuration 28, and the water is urged out of the sprayer 64 to apply water to a lawn or other application surface. Water which travels through the first channel 38 of the upper segment 30 of the riser 24 is released through spoke tubes 72 of the sprayer 64 that have outlets 74 facing generally forwardly and upwardly with respect to the upper segment 30.

Water which travels through the second channel 42 is released through spoke tubes 72 that have outlets 74 facing generally forwardly and downwardly with respect to the upper segment 30. Thus, the water from the first channel 38 travels further from the sprinkler apparatus 10 than water from the second channel 42 by nature of being moved upwardly as it is dispersed from the sprayer 64. Additionally, the larger bore size of the first channel 38 compared to the second channel 42 may lead to a comparatively lower pressure drop and greater flow. Some embodiments may also distribute water from the first channel 38 to a greater number of spoke tubes 72 than the second channel 42, which will also result in a lower pressure drop from the first channel 38 to its associated spoke tubes 72 than the second channel 42 to its associated spoke tubes 72.

As water is urged through the spoke tubes 72, the sprayer 64 is caused to rotate in the second rotational direction 78 as described above. This action of the sprayer 64 leads to the water being distributed generally evenly onto the lawn or other application surface. The action of the water against the turbine 82 also rotates the rotary portion 32 of the upper segment 30 of the riser 24 such that water is distributed to all surrounding areas of the lawn around the sprinkler apparatus 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A sprinkler apparatus comprising:
a base configured to attach to a fluid source, the base defining a volume therein;
a riser mounted to the base, the riser being positionable in an extended configuration in which the riser extends upwardly from and with respect to the base; and
a sprayer rotatably coupled to the riser opposite the base, the sprayer comprising a hub and a plurality of spoke tubes, the plurality of spoke tubes being coupled to and extending outwardly from the hub, the hub defining a first inlet which is in fluid communication with each spoke tube of the plurality of spoke tubes, each spoke tube of the plurality of spoke tubes having an outlet opposite the hub, each spoke tube of the plurality of spoke tubes being in fluid communication with the volume of the base via the first inlet of the hub.

2. The sprinkler apparatus of claim 1, wherein the base defines an inlet which extends into the base to the volume, the inlet being positioned at a bottom end of the base.

3. The sprinkler apparatus of claim 1, wherein the riser is movable between a retracted configuration and the extended configuration with respect to the base, the riser being positioned substantially in the volume of the base when in the retracted configuration.

4. The sprinkler apparatus of claim 3, wherein the riser is biased toward the retracted position.

5. The sprinkler apparatus of claim 3, wherein the riser is telescopically extendable from the retracted configuration to the extended configuration.

6. The sprinkler apparatus of claim 5, wherein the riser comprises an upper segment and a lower segment, the upper segment and the lower segment being positioned in the base when the riser is in the retracted configuration, the lower segment extending between the upper segment and the base when the riser is in the extended configuration.

7. The sprinkler apparatus of claim 6, wherein the sprayer is positioned at an upper end of the upper segment of the riser.

8. The sprinkler apparatus of claim 7, wherein:
the hub defines a second inlet opposite the first inlet, the second inlet being in fluid communication with each spoke tube of the plurality of spoke tubes; and
the upper segment of the riser defines a first channel and a second channel, the first inlet of the sprayer being in fluid communication with the volume of the base via the first channel, the second inlet of the sprayer being in fluid communication with the volume of the base via the second channel.

9. The sprinkler apparatus of claim 8, wherein the first channel has a bore size which is greater than a bore size of the second channel.

10. The sprinkler apparatus of claim 8, wherein an outlet of the first channel and an outlet of the second channel are oriented to direct fluid away forwardly with respect to the upper segment of the riser.

11. The sprinkler apparatus of claim 10, wherein the outlet of the first channel is positioned above the outlet of the second channel.

12. The sprinkler apparatus of claim 7, further comprising a biasing assembly coupled to the riser and biasing the riser toward the retracted configuration.

13. The sprinkler apparatus of claim 12, wherein the biasing assembly comprises an upper compression spring and a lower compression spring, the upper compression spring being positioned between a bottom flange of the upper segment of the riser and a top inner surface of the lower segment of the riser, the lower compression spring being positioned between a lower flange of the lower segment of the riser and a top interior surface of the base.

14. The sprinkler apparatus of claim 7, further comprising a rotation mechanism operatively coupled to the upper segment of the riser, the rotation mechanism being configured to rotate the upper segment about a vertical axis extending through a top end and a bottom end of the base.

15. The sprinkler apparatus of claim 14, wherein the rotation mechanism comprises a turbine mounted in the upper segment and a gearbox operatively coupled to the turbine, the gearbox being operatively coupled to a rotary portion of the upper segment, the sprayer being mounted to the rotary portion.

16. The sprinkler apparatus of claim 1, wherein the sprayer is rotatable about a horizontal axis with respect to the base which extends through the hub.

17. The sprinkler apparatus of claim 1, wherein each spoke tube of the plurality of spoke tubes being curved from the hub in a first rotational direction around the hub, the first rotational direction extending around a rotational axis of the sprayer.

18. A sprinkler apparatus comprising:
a base configured to attach to a fluid source, the base defining a volume therein, the base defining an inlet which extends into the base to the volume, the inlet being positioned at a bottom end of the base;
a riser mounted to the base, the riser being movable between a retracted configuration and an extended configuration with respect to the base, the riser being positioned substantially in the volume of the base when in the retracted configuration, the riser extending upwardly from and with respect to the base when in the extended configuration, the riser being telescopically extendable from the retracted configuration to the extended configuration, the riser comprising an upper segment and a lower segment, the upper segment and the lower segment being positioned in the base when the riser is in the retracted configuration, the lower segment extending between the upper segment and the base when the riser is in the extended configuration, the riser being biased toward the retracted position;
a sprayer rotatably coupled to an upper end of the upper segment of the riser, the sprayer comprising a hub and a plurality of spoke tubes, the plurality of spoke tubes being coupled to and extending outwardly from the hub, the hub defining a first inlet and a second inlet opposite each other, the first inlet and the second inlet being in fluid communication with each spoke tube of the plurality of spoke tubes, each spoke tube of the plurality of spoke tubes having an outlet opposite the hub, the sprayer being rotatable about a horizontal axis with respect to the base which extends through the hub, each spoke tube of the plurality of spoke tubes being curved from the hub in a first rotational direction around the hub, the first rotational direction extending around the horizontal axis of the sprayer;
wherein the upper segment of the riser defines a first channel and a second channel, the first inlet of the sprayer being in fluid communication with the volume of the base via the first channel, the second inlet of the sprayer being in fluid communication with the volume of the base via the second channel, the first channel having a bore size which is greater than a bore size of the second channel, an outlet of the first channel and an outlet of the second channel being oriented to direct fluid away forwardly with respect to the upper segment of the riser, the outlet of the first channel being positioned above the outlet of the second channel;
a biasing assembly coupled to the riser and biasing the riser toward the retracted configuration, the biasing assembly comprising an upper compression spring and a lower compression spring, the upper compression spring being positioned between a bottom flange of the upper segment of the riser and a top inner surface of the lower segment of the riser, the lower compression spring being positioned between a lower flange of the lower segment of the riser and a top interior surface of the base; and
a rotation mechanism operatively coupled to the upper segment of the riser, the rotation mechanism being configured to rotate the upper segment about a vertical axis extending through a top end and the bottom end of the base, the rotation mechanism comprising a turbine mounted in the upper segment and a gearbox operatively coupled to the turbine, the gearbox being operatively coupled to a rotary portion of the upper segment, the sprayer being mounted to the rotary portion.
